(19) United States
(12) Patent Application Publication
(10) Pub. No.: US 2006/0122932 A1
(43) Pub. Date: Jun. 8, 2006

(54) Efficient and incentivized enrollment in an automatic payment program for recurring bills

(75) Inventors: Diane L. Birtwell, Chicago, IL (US); Sally A. Balsamo, Park Ridge, IL (US); Matthew Sloan, Winnetka, IL (US); Edward Stolbof, Wilmette, IL (US)

Correspondence Address: LEYDIG VOIT & MAYER, LTD, TWO PRUDENTIAL PLAZA, SUITE 4900, 180 NORTH STETSON AVENUE, CHICAGO, IL, 60601-6780, US

(73) Assignee: Discover Financial Services, Inc., Riverwoods, IL (US)

(21) Appl. No.: 11/001,246

(22) Filed: Dec. 1, 2004

(51) Int. Cl. G06Q 40/00

(52) U.S. Cl. 705/40

(57) ABSTRACT

Systems and methods are described for a customer to enroll in and manage a program for automatic payment for the recurring bills of a number of merchants within a single interface. The interface can be provided by the customer's credit card-issuing financial institution, which contacts the customer-selected merchants and arranges for automatic payment via the credit card. As an incentive for the customer's enrollment, an award such as award points or a lower rate of interest can be provided with respect to the automatically made transactions.

### FIELD OF THE INVENTION

This invention pertains generally to the field of consumer bill payment, and more particularly to a credit card-based automatic bill payment program providing convenience and incentives for enrollment and usage.

### BACKGROUND OF THE INVENTION

Over the past several years, consumers have become inundated with an increasing number of recurring bills for goods and services provided on a regular basis. Examples of such recurring goods and services are: cable or satellite television service; internet service; mobile phone service; product-of-the-month clubs; electric utilities, etc. Rather than bill the customer and wait for payment on a regular basis for these goods and services, an increasing number of merchants are providing an option for automatic payment. Under this option, a consumer provides the merchant with financial information such as credit card or checking account numbers and pre-authorizes the merchant to charge goods and services to the card or make withdrawals from the checking account. This is a benefit to both the consumer, who has one less bill to manage on a regular basis, and to the merchant, who, at least in the case of credit card payments, is guaranteed against customer delinquency by ensuring that the card-issuing financial institution will be charged for the goods and services provided.

Also over the past several years, credit cards and other financial alternatives to currency have boomed in the marketplace. Consumers now routinely use credit cards to pay for goods and services from a vast spectrum of merchants. As the use of credit cards has increased, so has the competition by the financial institutions providing these cards. As a result, many financial institutions provide incentives to consumers to use their particular cards. These incentives include cash rebates, low interest rates on balances carried from month to month, and miles or points in travel programs.

Previously existing systems and methods for using a credit card for the automatic payment of recurring bills have required a consumer to enroll in such services on a merchant-by-merchant basis, typically by contacting each merchant separately to arrange for automatic payment. As a result, enrolling in the automatic bill payment services of several merchants has been a time-consuming process for the consumer, requiring several transactions. This time-consumption is compounded should a consumer later wish to, for example, update each of the merchants with new credit card information.

Additionally, previously existing systems and methods for automatic bill payment services tended not to favor one financial institution over another with respect to the credit cards they issue. That is, there has been no incentive to use a particular institution's credit card as part of a merchant's automatic bill payment service.

### SUMMARY OF THE INVENTION

Embodiments of the invention provide systems and methods for a customer to enroll in and manage a program for automatic payment for the recurring bills of a number of merchants within a single interface. The interface can be provided by the customer's credit card-issuing financial institution, which contacts the customer-selected merchants and arranges for automatic payment via the credit card. As an incentive for the customer's enrollment, an award such as award points or a lower rate of interest can be provided with respect to the automatically made transactions.

In an embodiment of the invention, a method is provided for enrolling a customer into an automatic bill payment service, the service making payments for the customer from a financial institution to one or more merchants, the method comprising receiving, from the customer, a request corresponding to the one or more merchants, and instructing the one or more merchants identified in the request to make automatic charges to an account at the financial institution, the account corresponding to the customer, and the automatic charges to be made in response to the generation of recurring bills by the one or more merchants for the customer.

In another embodiment, a method is provided for promoting a customer of a financial institution to use an automatic payment service for recurring bills of one or more merchants, the method comprising enrolling the customer into the automatic payment service for the one or more merchants, receiving, from one of the merchants in response to the generation of a recurring bill and without customer interaction, a charge for goods or services provided or to be provided to the customer, charging an account of the customer at the financial institution, and providing an award relative to the charge.

In still another embodiment, a method is provided for automatically paying recurring bills for a customer of a financial institution comprising receiving, from a merchant, a request for payment for goods or services provided or to be provided by the merchant to the customer, the request being one of a recurring series, transmitting payment to the merchant for the goods or services in response to the request, charging a customer account at the financial institution in connection with the payment, and providing an award to the customer, the award associated with the charge to the customer account at the financial institution, wherein the merchant provides similar goods or services to the customer on a recurring basis, and wherein the customer has previously authorized that bills for the recurring provisions of similar goods or services be paid by the financial institution and charged to the customer account at the financial institution, and wherein the previous authorization was given directly to the financial institution, and the financial institution communicated the authorization to the merchant.

In yet another embodiment, a system is provided for enrolling a customer and managing the customer's enrollment in an automatic bill payment service, the service making payments for the customer from a financial institution to one or more merchants, the system comprising an account database including a record of an account of the customer at the financial institution, and an interface for entering information pertaining to the customer and one or more accounts of the customer at one or more identified merchants which are instructed to make automatic charges to the customer account at the financial institution, the automatic charges to be made in response to the generation of recurring bills for the one or more accounts of the customer at the one or more merchants.

In a still further embodiment, a system is provided for automatically paying recurring bills for a customer of a financial institution comprising a request, received from a merchant, for payment for goods or services provided or to be provided by the merchant to the customer, the request being one of a recurring series, a payment, transmitted to the merchant for the goods or services in response to the request, a charge, made to a customer account at the financial institution in connection with the payment, and an award, provided to the customer and associated with the charge to the customer account at the financial institution, wherein the merchant provides similar goods or services to the customer on a recurring basis, and wherein the customer has previously authorized that bills for the recurring provisions of similar goods or services be paid by the financial institution and charged to the customer account at the financial institution, and wherein the previous authorization was given directly to the financial institution, and the financial institution communicated the authorization to the one or more merchants.

### BRIEF DESCRIPTION OF THE DRAWINGS

While the appended claims set forth the features of the present invention with particularity, the invention and its advantages are best understood from the following detailed description taken in conjunction with the accompanying drawings, of which:

FIG. 1 is a general overview of the operation of a method and system contemplated by an embodiment of the present invention;

FIG. 2 is a flow diagram illustrating a method for enrolling in an automatic bill payment program, in accordance with an embodiment of the invention;

FIG. 3 is a flow diagram illustrating a method of automatically paying recurring bills, in accordance with an embodiment of the invention;

FIG. 4 is an exemplary form interface for enrolling in an automatic bill payment program, in accordance with an embodiment of the invention; and

FIG. 5 is a sample of financial statements reflecting participation in an automatic bill payment program, in accordance with an embodiment of the invention.

### DETAILED DESCRIPTION OF THE INVENTION

For a financial institution issuing credit cards, a goal is to increase the frequency and regularity with which consumers use that institution's cards. For a merchant billing a customer for goods or services on a recurring basis, a goal is to ensure that the customer regularly and timely pays the recurring bills. For a customer of several merchants who bill on a recurring basis, a goal is to reduce the amount of time and energy spent performing recurring transactions. A recurring billing enrollment and management system, whereby a customer can enroll and manage automatic bill payment for a number of merchants within a single interface, can achieve all of these goals in a win-win-win situation. To further increase the benefit to the consumer, a financial institution, merchant, or both can provide additional incentives for the consumer to enroll.

For simplicity, the description that follows will be provided by reference to a specific type of financial alternative to currency known in the art as a “credit card”. However, as will be clear to those skilled in the art, no aspect of the present invention is specifically limited to credit card applications. Therefore, it is intended that the following description also encompass the use of the present invention with many other forms of financial alternatives to currency, including debit cards, smart cards, single-use cards, pre-paid cards, electronic currency (such as might be provided through a cellular telephone or personal digital assistant), automated collection systems (such as an electronic toll collection system), and the like.

Similarly, while the description that follows will, for simplicity, be provided by reference to a specific type of award (or “reward”), known in the art as a reduced annual percentage rate (APR) of interest, it is not intended to limit the use of the present invention to award systems dealing only with interest charges on unpaid balances. For example, the present invention can be applied to award programs offering cash rebates, certificates, coupons, credits, discounts, refunds, and the like. In addition, the present invention is equally applicable to award systems based on airline miles, hotel frequent stay points, and the like, and the description that follows is intended to encompass all such awards.

A financial institution providing alternatives to currency, such as credit cards, generally receives income from at least two sources: (1) the merchant, who remits to the financial institution a fee that is customarily a small fixed transaction fee plus a percentage of the purchase price of an item purchased by a consumer using the financial institution's credit card and (2) the consumer, who pays interest charges on unpaid balances that are generally, for consumer purchases, at a rate in excess of the prime rate of interest. Therefore, to increase income, a financial institution offering credit cards seeks to increase the total number of transactions and the total value of goods purchased by consumers using that institution's credit cards, which directly increases the income received from merchant fees and indirectly may increase the unpaid balance maintained by consumers, thereby increasing interest revenue. One common mechanism for increasing the total value of the goods purchased by consumers using the financial institution's credit cards is to offer an award, such as a cash rebate award, that is directly based on the total value of the goods purchased within a given time frame.

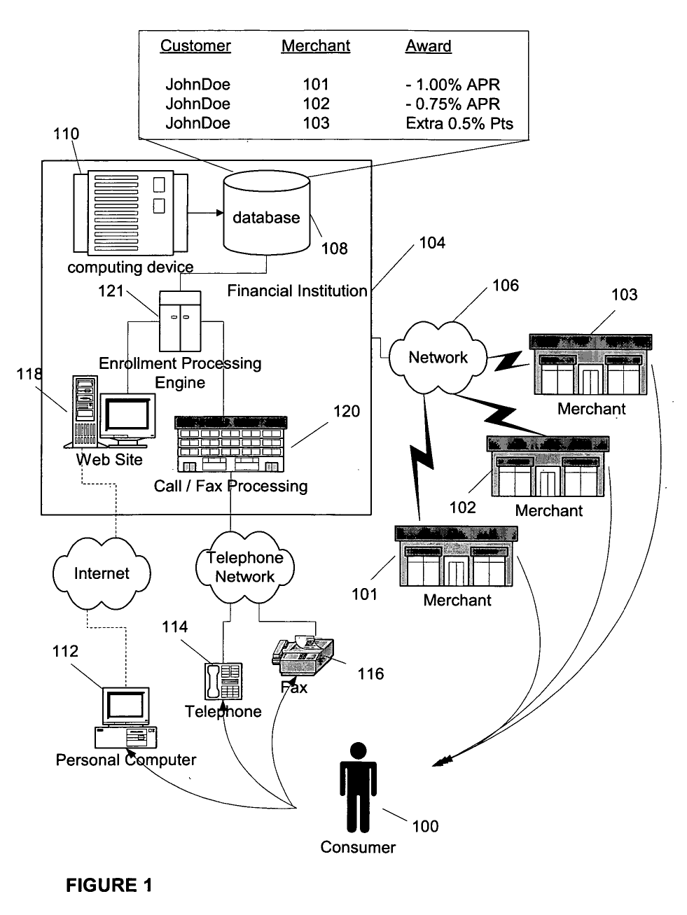

Turning to FIG. 1, an implementation of the recurring billing enrollment and management system contemplated by an embodiment of the present invention is shown with reference to an overall credit card usage environment. A consumer 100 can use a credit card to purchase goods or services at any number of locations. Exemplary locations illustrated in FIG. 1 include three merchants 101, 102, 103. Although the merchants 101, 102, 103 are depicted in FIG. 1 as brick-and-mortar stores, the merchants 101, 102, 103 need not be so limited in physical presence. For example, the merchants 101, 102, 103 could include a telephone-based retailer, a computer-based retailer operating a web site, a mail-order catalog retailer, or a merchant transacting business through some other medium. As will be known by those skilled in the art, each merchant may offer a variety of goods and services. For example, one of the merchants 101 can be a grocery store or mass-market retailer, or it can be a doctor's office or an accountant's office. Similarly one of the merchants 102 can, for example, be a catalog retailer or a public utility, such as a phone or cable company. Additionally, one of the merchants 103 can, for example, be an on-line retailer, or it can be an interface to private party transactions, such as through an auction web site.

Once the consumer 100 has decided to purchase goods or services, using a credit card, from one of the merchants 101, 102, 103, an authorization can be obtained from a financial institution 104. Generally, financial institution 104 is the issuer of the credit card being used by the consumer. An authorization from the financial institution 104 allows the consumer 100 to receive goods and services from the merchants 101, 102, 103 and allows the merchants to be reimbursed by the financial institution 104.

Typically, an authorization can be obtained from the financial institution 104 through a network 106, which can be the Internet, a dedicated secure network, or even the phone system, such as through a voice phone call to a representative of the financial institution 104. The financial institution 104 can maintain a database, such as database 108 to record each of the transactions performed by consumers using the financial institution's credit cards. A computing device or system, such as computing device 110, can be used to monitor the transactions stored in the database 108, and can calculate various derived information, including interest charges, balances, spending habits, and awards, though, for simplicity, only the latter is illustrated in FIG. 1.

The consumer 100 can use a credit card at certain providers of goods or services, such as merchants 101, 102, 103. The providers can communicate with the financial institution 104, such as through the network 106, to obtain authorization for the consumer's purchase and to receive reimbursement from the financial institution. The financial institution can store the transaction in a database 108 and can determine, based upon known algorithms that could be stored in computing device 110, the amount owed to the financial institution 104 by the consumer 100. The financial institution 104 can derive revenue from both the fees charged for the transaction to the providers such as merchants 101, 102, 103, and it can derive revenue from fees and interest charges paid by the consumer 100.

To encourage increased card usage by consumers, the financial institution 104 can implement a system for automatic payment of a consumer's recurring bills. For example, if one of the merchants 102 is a mobile telephone service company that bills the consumer 100 monthly for services, then the consumer 100 can elect to have those bills automatically paid by the financial institution 104 via his credit card. This alleviates the need for the consumer 100 to remember to pay his monthly bill, while ensuring that the mobile telephone company is paid timely for services provided. The financial institution 104 is now guaranteed a regular recurring transaction by the consumer 100, without any further intervention required by the consumer 100.

In previously existing automatic payment systems, the consumer 100 was required to enroll directly with individual merchants. Thus, if the consumer 100 wanted to enroll in automatic bill payment for each of the three merchants 101, 102, 103, then three separate enrollments were necessary, and there was generally no requirement that a credit card issued by any particular financial institution 104 be used. Embodiments of the present invention allow a consumer 100 to enroll for automatic bill payment to multiple merchants 101, 102, 103, in a single transaction and can ensure that those merchants 102 bills for the consumer 100 are paid via a credit card issued by the financial institution 104. Moreover, as an incentive for consumers to participate in the automatic bill payment program, embodiments of the invention provide an award to the consumer. The award can be a one-time award for enrolling in the program—for example, a cash award or prize—or can be an ongoing award, such as a lower rate of interest on transactions made via the program. More details on the award are discussed below.

An overview of the enrollment process is shown in FIG. 1. The consumer 100 contacts the financial institution 104 to request enrollment in automatic bill payment for one or more of the merchants 102. In embodiments of the invention, the consumer 100 can enroll through any of several different media. For example, the consumer 100 can enroll online via a personal computer 112, by voice over a telephone 114, or by facsimile through a fax machine 116. Alternatively, the consumer 100 can enroll by sending a form through the mail or by courier. Other enrollment techniques can also be made available for the convenience of the consumer 100, and the present invention is not limited to the examples listed above.

In an embodiment of the invention, the financial institution 104 receives enrollment requests through, for example, a web site 118 that allows the consumer 100 to interact with his personal computer 112, or from a call/fax processing center 120 that receives calls and faxes made by the consumer 100 via the telephone 114 or fax machine 116. Additionally, a mail processing center (not shown) can be used for processing enrollment requests delivered by mail. The web site 118, call/fax processing center 120 and mail processing center can be operated directly by the financial institution 104 or by an outside business partner or vendor. The web site 118, call/fax processing center 120 and other enrollment processing centers facilitate the entry of the consumer's 100 enrollment data into the financial institution's 104 database 108 through, for example, an enrollment processing engine 121. The financial institution 104 contacts the merchants 101, 102, 103 and notifies them that the consumer 100 has enrolled in the recurring billing automatic payment program and has authorized regular charges to his credit card account at the financial institution 104.

Along with transactional information, the database 108 or an associated database of the financial institution 104 contains information pertaining to the consumer's 100 participation in the recurring billing automatic payment program. For example, in one embodiment of the invention, the database 108 contains information regarding the consumer 100, a particular merchant 102 for which the consumer 100 has enrolled in the program, and the type of award provided to the consumer 100, such as the APR discount to be applied to the corresponding transactions with this merchant 102.

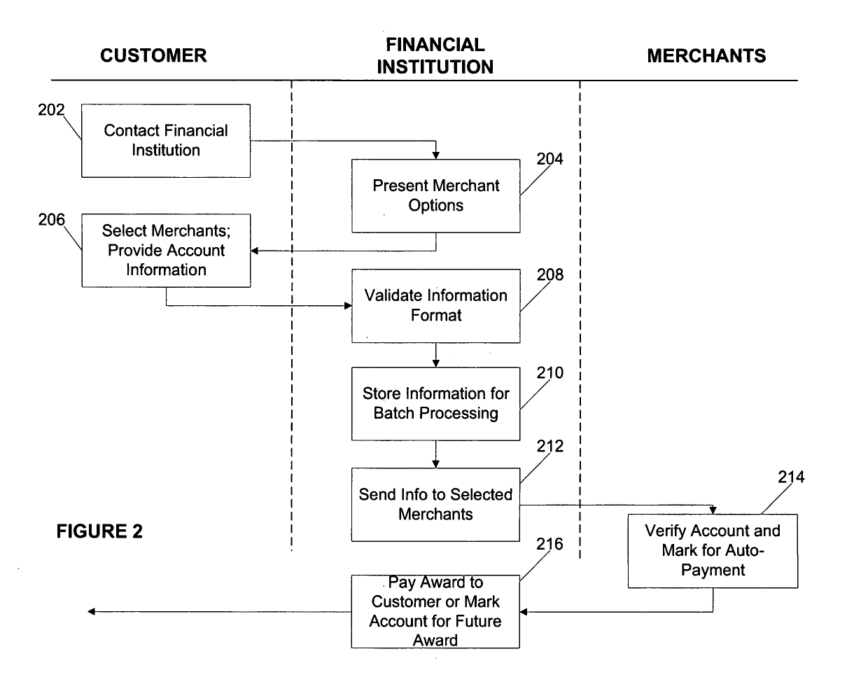

Turning to FIG. 2, a flow diagram is shown illustrating a method of a customer enrolling in a recurring billing automatic payment system of a financial institution for a number of merchants, as used in an embodiment of the invention. The customer initiates contact with the financial institution at step 202. The contact medium can be any of a variety of types including, but not limited to: electronic via, for example, the internet; or telephonic, via, for example, either a live person or an interactive voice response system. Additionally, the contact medium may be of an “offline” nature, for example, by facsimile or postal carrier.

The financial institution presents enrollment options for the customer at step 204. The options can include, for example, a list of all merchants participating in the financial institution's recurring billing automatic payment program. The list can enumerate all the merchants, or alternatively, can be part of an interactive system that enumerates only a merchant or range of merchants described by the customer. Alternatively, the enrollment options can include a blank form on which the customer enumerates those merchants for which he would like to have his bills paid automatically.

At step 206, the customer selects merchants using the options presented in step 204. This can be done by checking off those merchants in a computer interface, or writing the names of those merchants on a blank form. The customer additionally provides relevant account information that may be necessary to identify the correct merchant account for payment. Such relevant account information can include, for example, the customer's account number with the merchant, billing address with the merchant, and other information useful in confirming the identity of the financial institution customer with the merchant. Confidently identifying the correct customer can aid in deterring and preventing fraudulent use of the recurring billing automatic payment program. Also preferably included in the customer information is an authorization for the merchants to charge the customer's account at the financial institution for the recurring bills, in accordance with terms of the recurring billing automatic payment program.

The selection of merchants is delivered to the financial institution where, in one embodiment of the invention, the account information for the various merchants is validated for formatting at step 208. Format validation, such as, for example, that account numbers contain the correct number of digits and are in proper alphanumeric form, help minimize formatting errors prior to the financial institution contacting the respective merchants with the information. Alternatively, the financial institution need not validate the account information.

Once the customer's merchant information is received, it is stored at step 210 for later batch processing with the merchants. By using batch operations, rather than enrolling in real-time, the financial institution can provide the customer with enrollment interfaces that are not limited to real-time processing. It therefore may be significantly easier for some customers to enroll than if they were so limited. For example, customers can mail in a form, or speak the information via telephone to the financial institution where it need only be received and stored for later processing. Of course, real-time processing may be provided as an alternative.

The financial institution, as part of a batch process, sends the customer's information to the respective merchants at step 212. This is preferably accomplished electronically, such as via a private network or over a ‘virtual’ private network (VPN), but may also be accomplished by mail or courier, or even by telephone or facsimile. A customer-selected merchant receives the customer information and verifies it with the customer's account information to ensure the correct identity of the customer and merchant account at step 214. The merchant marks the account for auto-payment of future recurring bills and preferably confirms with the financial institution that the customer has successfully enrolled.

At step 216, the financial institution pays an incentive award, such as an immediate cash award, to the customer for successful enrollment. Alternatively, the financial institution marks the account for future awards, such as a lower APR on automatically-paid recurring bill transactions with the merchant. Additionally or alternatively, an award is paid by or to the merchant. In one embodiment, a reduced merchant discount rate is awarded to the merchant for the recurring transactions, so that payment to the merchant by the financial institution is discounted less than it otherwise would be. In one embodiment, the award to the customer is paid prior to step 208, based merely on the customer's enrollment and not relying on any ensuing transactions.

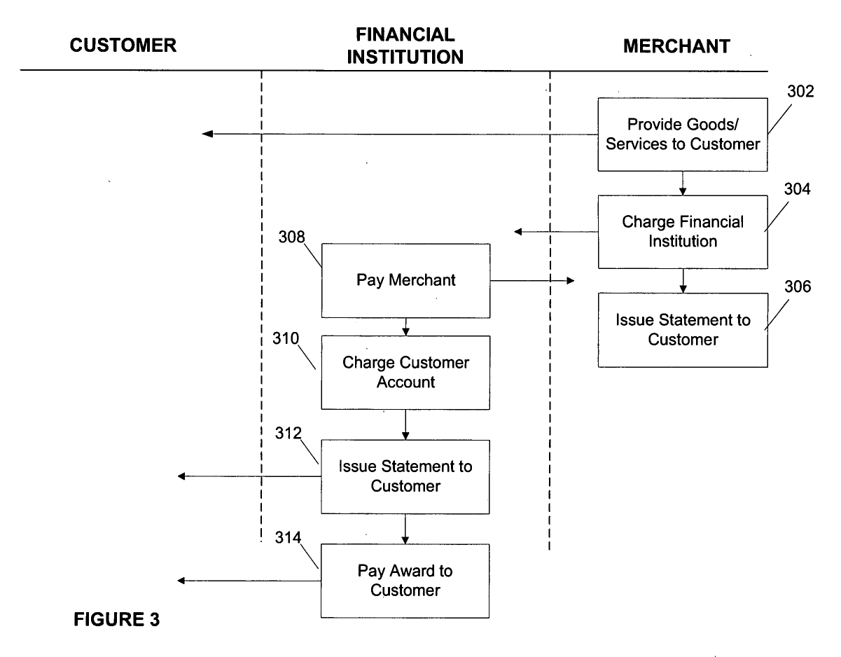

Turning attention to FIG. 3, a flow diagram is shown illustrating a method of a financial institution automatically paying the recurring bills of a customer to a merchant, as used in an embodiment of the invention. The merchant, typically in an ordinary and recurring course of business, provides goods or services to the customer at step 302. The merchant, having received prior authorization from the customer, charges the financial institution for this billing period's goods or services at step 304. The merchant uses a special code for the transaction that marks it as a transaction made pursuant to the recurring billing automatic payment program. The merchant issues a statement to the customer at step 306, preferably indicating that payment has been made through a charge to the customer's financial institution credit card. The financial institution, receiving the charge from the merchant, pays or reimburses the merchant at step 308, less any applicable transactions fees, as is typically done by financial institutions in the credit card industry. The payment will be made on the day the payment would otherwise be due to the merchant from the customer. Alternatively, the user may select that the payment be made at some other time. The financial institution charges the customer's account at step 310. On a generally monthly basis, the financial institution issues a statement to the customer at step 312 listing charges made to the customer's account for the previous month by merchants and for any interest and finance charges from previous account balances.

In an embodiment of the invention, the financial institution pays an award to the customer at step 314. The award corresponds to the transaction made with the merchant as part of the recurring billing automatic payment program and is paid preferably in addition to any other routine awards that the customer may receive. Preferably, the award is a discount for that transaction on the interest rate normally charged to the account. Thus, if the customer is carrying a revolving balance, then the transaction will incur an interest charge at the discounted rate. Alternatively, as discussed above, the award is a cash rebate, travel miles, award points, affinity program points or other type of award. Additionally or alternatively, an award is paid by or to the merchant. For example, in one embodiment, the merchant is charged a reduced transaction fee by the financial institution, as an incentive for the merchant's participation in the program. In another embodiment, the merchant is awarded a reduced merchant discount rate for the recurring transactions, so that payments to the merchant by the financial institution for these transactions are discounted less than they otherwise would be.

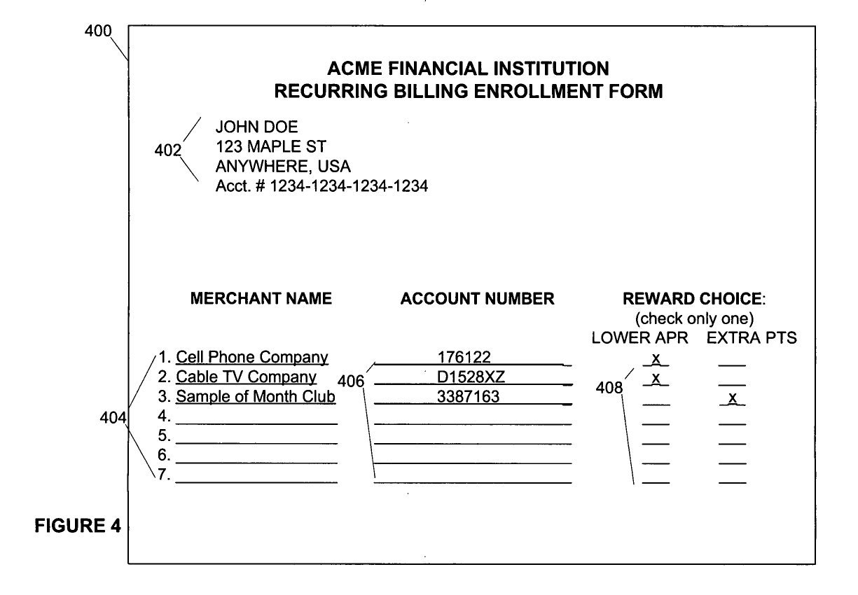

An illustrative example form by which a customer can enroll in a recurring billing automatic payment system is shown in FIG. 4. The form 400 is produced by the financial institution that issued the customer's credit card. It contains the customer's identifying information, including, for example, the customer's name, address and credit card account information 402. The form 400 contains an area 404 where the customer can specify a number of merchants of which he is a recurring customer. Also provided on the form 400 is an area 406 for specifying account information, such as the account number, for each merchant listed in merchant area 404. In one embodiment, the form 400 also contains options 408 for the customer to specify a choice of award. In the example of FIG. 4, the customer can specify either a lower interest rate or extra award points as the award. Alternatively, no options area 408 is provided and the type of award is selected without input from the customer by, for example, prior agreement between a merchant and the financial institution. Alternatively, an options area is provided to allow a single choice of award for all a customer's merchants, but not on a merchant by merchant basis.

In embodiments of the invention, form 400 need not be a physical form. The form 400 can be presented, for example, as a user interface on a computer via an internet web browser. A single list of all participating merchants may be presented via the web browser, allowing the user to select chosen merchants and then provided the required account information. A hierarchy of forms may be presented via the web browser in an alternate embodiment. Accordingly, the user would choose first a category of merchants, such as “mobile telephone service providers”, from a list o f various categories. Then, in response to the chosen category, the user would be presented with a list of participating merchants in the chosen category, allowing the user to choose among them. Alternatively, the form is filled in by an agent of the financial institution at the verbal instruction of the customer via, for example, a telephone call.

In addition to allowing a customer to enroll in a recurring billing automatic payment system, in some embodiments of the invention form 400 or a similar form can be used for related enrollment management activities. For example, in an embodiment of the invention, a user uses form 400 or a similar form to check the status of his enrollment in the system. Such status checking can be done with respect to pending enrollments (i.e., merchants for which the user's recent enrollment has not yet been fully processed) or completed enrollments. A user checking the status of enrollment can thus know whether a particular bill will be paid by the automatic payment system during that billing cycle, or if an enrollment's “pending” status will prevent such payment. An embodiment of the invention further provides relevant messages or feedback to the user via the status checking, so that the user is kept aware of important information, such as, for example, changes to the incentive award.

In an embodiment of the invention, a user further uses form 400 or a similar form to change enrollment information at his leisure. In this manner, a user can modify how the automatic payments are made from the financial institution by, for example, changing the account information for a merchant, or by disenrolling in the system for a single merchant or for multiple merchants.

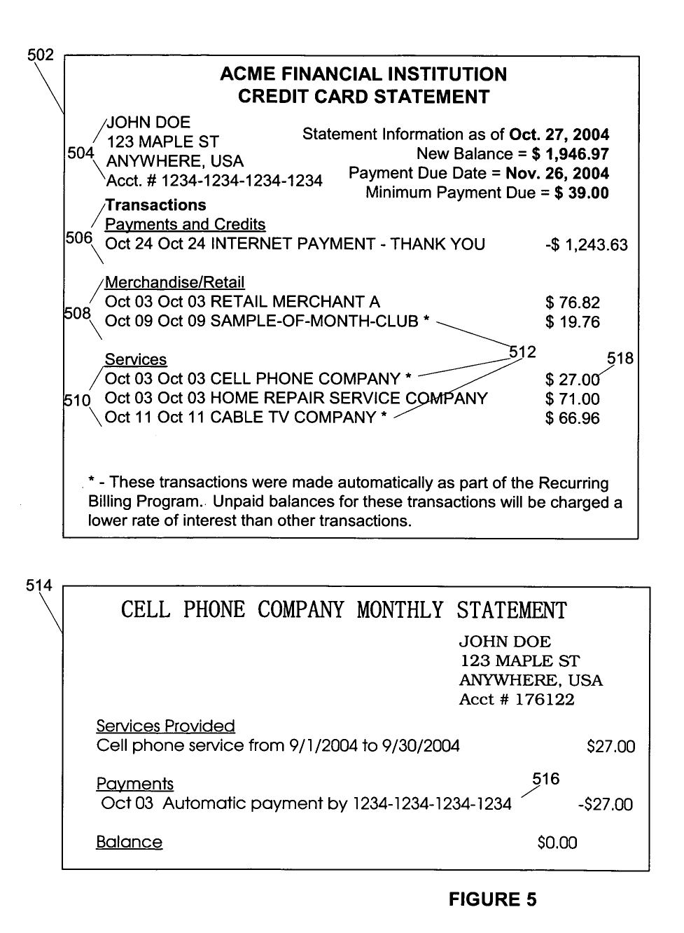

Turning attention to FIG. 5, two exemplary financial statements are displayed. The first statement 502 is a credit card statement that has been issued by the financial institution to the customer who is participating in the financial institution's recurring billing automatic payment program. The statement contains information typical of a credit card statement, such as general account information 504, payments and credits 506, and transaction data grouped by merchant type, such as merchandise/retail 508 and services 510. Certain transactions 512 are marked with asterisks, indicating they have been made without specific customer authorization, but rather as part of a recurring billing program.

The second statement 514 is a mobile telephone service company statement for services provided to the customer. The statement indicates that a payment 516 was automatically made by charging the customer's credit card. This payment 516 corresponds to the asterisked transaction 518 on the customer's credit card statement 502.

In view of the many possible embodiments to which the principles of the present invention may be applied, it should be recognized that the embodiments described herein with respect to the drawing figures are meant to be illustrative only and should not be taken as limiting the scope of the invention. For example, the invention is not limited to awards of lower interest rates: other types of awards are contemplated, such as cash rebates and affinity program points. Additionally, those of skill in the art will recognize that the illustrated embodiments can be modified in arrangement and detail without departing from the spirit of the invention. Therefore, the invention as described herein contemplates all such embodiments as may come within the scope of the following claims and equivalents thereof.

What is claimed is:

1. A method for enrolling a customer into an automatic bill payment service, the service making payments for the customer from a financial institution to one or more merchants, the method comprising:
receiving, from the customer, a request corresponding to the one or more merchants; and
instructing the one or more merchants identified in the request to make automatic charges to an account at the financial institution, the account corresponding to the customer, and the automatic charges to be made in response to the generation of recurring bills by the one or more merchants for the customer.

2. The method of claim 1 further comprising:
presenting to the customer an interface for enrolling in the automatic bill payment service; and
wherein the request corresponds to a customer selection via the interface and the receiving is performed via the interface.

3. The method of claim 2 wherein the interface is presented by one or more of: telephone; facsimile; mail or internet.

4. The method of claim 2 wherein the interface includes one or more fields for entering information pertaining to the customer and one or more accounts of the customer with the one or more merchants.

5. The method of claim 1 further comprising:
providing the customer an award from the financial institution.

6. The method of claim 5 wherein the award comprises one or more of: cash; prizes; affinity program points; travel miles; or a lower rate of interest.

7. The method of claim 5 wherein providing the award comprises indicating, in connection with the customer account at the financial institution, that a special rate of interest is applied to charges for the recurring bills.

8. The method of claim 1 further comprising:
storing the request in a batch file for subsequent processing.

9. The method of claim 1 wherein the method is performed without direct communication between the customer and the one or more merchants.

10. A method for promoting a customer of a financial institution to use an automatic payment service for recurring bills of one or more merchants, the method comprising:
enrolling the customer into the automatic payment service for the one or more merchants;
receiving, from one of the merchants in response to the generation of a recurring bill and without customer interaction, a charge for goods or services provided or to be provided to the customer;
charging an account of the customer at the financial institution; and
providing an award relative to the charge.

11. The method of claim 10 wherein the charge received from the one of the merchants is coded to indicate it has been made in accordance with the automatic payment service.

12. The method of claim 10 wherein the award comprises a rate of interest on the charge that is less than a customary rate of interest.

13. The method of claim 10 wherein the award comprises one or more of: cash; prizes; affinity program points; or travel miles.

14. A method for automatically paying recurring bills for a customer of a financial institution comprising:
receiving, from a merchant, a request for payment for goods or services provided or to be provided by the merchant to the customer, the request being one of a recurring series;
transmitting payment to the merchant for the goods or services in response to the request;
charging a customer account at the financial institution in connection with the payment; and
providing an award to the customer, the award associated with the charge to the customer account at the financial institution;
wherein the merchant provides similar goods or services to the customer on a recurring basis, and wherein the customer has previously authorized that bills for the recurring provisions of similar goods or services be paid by the financial institution and charged to the customer account at the financial institution, and wherein the previous authorization was given directly to the financial institution, and the financial institution communicated the authorization to the merchant.

15. The method of claim 14 wherein the award comprises one or more of: cash; prizes; affinity program points; travel miles; or a special rate of interest.

16. The method of claim 14 further comprising:
verifying that the customer has enrolled in a recurring billing program with-the financial institution, whereby the customer has authorized that bills for the recurring provisions of similar goods or services be paid by the financial institution and charged to the customer account at the financial institution.

17. The method of claim 14 wherein the method is performed without action from the customer.

18. The method of claim 17 wherein the method is performed without direct communication between the customer and the merchant.

19. A system for enrolling a customer and managing the customer's enrollment in an automatic bill payment service, the service making payments for the customer from a financial institution to one or more merchants, the system comprising:
an account database including a record of an account of the customer at the financial institution; and
an interface for entering information pertaining to the customer and one or more accounts of the customer at one or more identified merchants which are instructed to make automatic charges to the customer account at the financial institution, the automatic charges to be made in response to the generation of recurring bills for the one or more accounts of the customer at the one or more merchants.

20. The system of claim 19 wherein the interface is presented by one or more of: telephone; facsimile; mail or internet.

21. The system of claim 19 further comprising:
an award provided to the customer from the financial institution; wherein the award comprises one or more of: cash; prizes; affinity program points; travel miles; or a special rate of interest.

22. The system of claim 19 further comprising:
a storage medium for storing a batch file, the batch file comprising the information entered via the interface; and
an enrollment processing engine for processing the batch file and communicating the automatic charging instructions to the one or more merchants.

23. A system for automatically paying recurring bills for a customer of a financial institution comprising:
a request, received from a merchant, for payment for goods or services provided or to be provided by the merchant to the customer, the request being one of a recurring series;
a payment, transmitted to the merchant for the goods or services in response to the request;
a charge, made to a customer account at the financial institution in connection with the payment; and
an award, provided to the customer and associated with the charge to the customer account at the financial institution;
wherein the merchant provides similar goods or services to the customer on a recurring basis, and wherein the customer has previously authorized that bills for the recurring provisions of similar goods or services be paid by the financial institution and charged to the customer account at the financial institution, and wherein the previous authorization was given directly to the financial institution, and the financial institution communicated the authorization to the one or more merchants.

24. The system of claim 23 wherein the award comprises one or more of: cash; prizes; affinity program points; travel miles; or a special rate of interest applied to the charge.

25. The system of claim 23 wherein no action is taken by the customer with respect to the request and payment.

26. The system of claim 25 wherein there is no communication between the customer and the merchant.
